(19) United States
(12) Patent Application Publication
(10) Pub. No.: US 2009/0172515 A1
(43) Pub. Date: Jul. 2, 2009

(54) DATA SEARCH APPARATUS AND DATA SEARCH METHOD THEREOF, AND STORAGE MEDIUM

(75) Inventor: Koji Kikuchi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/333,144

(22) Filed: Dec. 11, 2008

(30) Foreign Application Priority Data
Dec. 28, 2007 (JP) 2007-341283

(51) Int. Cl. G06F 17/21; G06F 17/30

(52) U.S. Cl. 715/226; 707/3

(57) ABSTRACT

A data search apparatus configured to search for content data that is to be populated into a field defined in a form, from among hierarchical data comprises an acquiring unit configured to acquire information about a layer range of content data that can be populated into the field, a search unit configured to search for content data within the layer range acquired by the acquiring unit as a candidate of the content data to be populated into the field, and an output unit configured to output the information about the content data searched by the search unit.

### BACKGROUND OF THE INVENTION

1. Field of the Invention

The present invention relates to a data search apparatus, a data search method thereof, and a storage medium, and in particular to the data search apparatus that is suitably used for populating data into a field defined in a form and outputting the form.

2. Description of the Related Art

In recent years, a technology for populating data into a field defined in a form and outputting the created form has been known. According to the technology, since the data and the form can be separately managed, a variety of forms is generally made available depending on usage. However, in such management, an amount of data managed by servers is greatly increased. Therefore, a method for searching for desired data has become important.

On the other hand, as a data managing method, a hierarchical management has been commonly used. Under the hierarchical management, a method for obtaining the desired data from among the hierarchically managed data has great significance.

For example, Japanese Patent Application Laid-Open No. 10-228489 discusses a technology that displays hierarchical data as search results in addition to data hit by a search to provide more information about the search results.

Further, Japanese Patent Application Laid-Open No. 2001-325299 discusses a technology that displays to a user a classification tree diverged from upper layers of classified items to lower layers thereof and enables the user to specify the classification tree in order to conduct the search by targeting the data located in the classification tree.

However, the data described in the technology according to Japanese Patent Application Laid-Open No. 10-228489 includes a lot of unnecessary data. Accordingly, it becomes hard work for the user to select the desired data to be output from a large amount of data, and the user may become unable to print the desired data.

Further, the technology according to Japanese Patent Application Laid-Open No. 2001-325299 conducts a search by targeting the data within a specified classification tree. Therefore, there arises a problem that, when data outside the specified range of the classification tree happens to be data that satisfies a search condition, the desired data may not be hit.

### SUMMARY OF THE INVENTION

The present invention is directed to a data search apparatus that allows the user to obtain only the data belonging to the layer desired by the user as the search results and realizes a more-effective data search.

According to one aspect of the present invention, a data search apparatus configured to search content data that is to be populated into a field defined in a form, from among hierarchical data, includes an acquiring unit configured to acquire information about a layer range of content data that can be populated into the field, a search unit configured to search for content data within the layer range acquired by the acquiring unit, as a candidate of the content data to be populated into the field, and an output unit configured to output the candidate of the content data satisfying the search conducted by the search unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates one example of a configuration of a form generation system according to a first exemplary embodiment of the present invention.

FIG. 2 illustrates one example of a configuration of a form management server and a client terminal according to the first exemplary embodiment of the present invention.

FIG. 3 illustrates one example of a configuration of modules in the form management server and the client terminal according to the first exemplary embodiment of the present invention.

FIGS. 4A and 4B illustrate one example of hierarchical data according to the first exemplary embodiment of the present invention.

FIG. 5 illustrates one example of a search instruction screen displayed when a data search is started, according to the first exemplary embodiment of the present invention.

FIG. 6 illustrates hierarchical data groups according to the first exemplary embodiment of the present invention.

FIG. 7 illustrates appropriate data when a search condition is specified for each data (data of “A01” to “D02”) illustrated in FIG. 6, according to the first exemplary embodiment of the present invention.

FIGS. 8A and 8B illustrate one example of a search method according to the first exemplary embodiment of the present invention.

FIG. 9 is a flowchart illustrating one example of an operation in the form generation system when a candidate of the data to be populated into the form is searched, according to the first exemplary embodiment of the present invention.

FIG. 10 illustrates one example of a setting screen displayed when search information including a layer range is previously set, according to a second exemplary embodiment of the present invention.

FIG. 11 illustrates one example of a search instruction screen displayed when a data search is started, according to a third exemplary embodiment of the present invention.

FIG. 12 is a flowchart illustrating one example of an operation in the form generation system when the form into which the data is populated is output, according to the third exemplary embodiment of the present invention.

FIG. 13 illustrates one example of each field defined in the form according to the third exemplary embodiment of the present invention.

FIG. 14 illustrates one example of a method of setting layer information of the field illustrated in FIG. 13, according to the third exemplary embodiment of the present invention.

FIGS. 15A and 15B illustrate one example of the form where the layers of the data to be populated into each field are set, according to the third exemplary embodiment of the present invention.

FIG. 16 illustrates one example of processing for defining a data item name for each field in the form when the form is generated according to a fourth exemplary embodiment of the present invention.

### DETAILED DESCRIPTION OF THE EMBODIMENTS

Various exemplary embodiments, features, and aspects of the invention will be described in detail below with reference to the drawings.

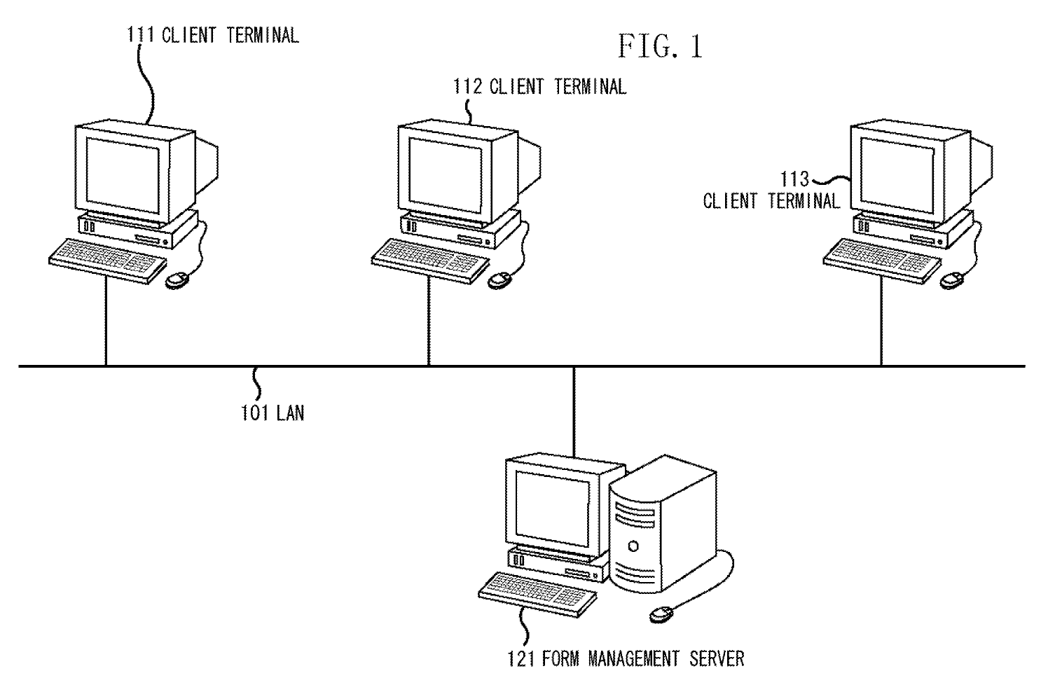

FIG. 1 illustrates one example of a configuration of a form generation system according to a first exemplary embodiment of the present invention. In FIG. 1, client terminals 111, 112, and 113 and a form management server 121 are connected to a local area network (LAN) 101 that is one example of a network.

The client terminals 111 to 113 are personal computers for clients (client PCs). According to the present exemplary embodiment, the client terminals 111 to 113 have a form generation function. An application program for performing the form generation function is installed in the client terminals 111 to 113.

The form management server 121 that is one example of a data search apparatus is a personal computer for a server (server PC). The form management server 121 functions as a form management system for managing a form used in the form generation system.

According to the present exemplary embodiment, the form management server 121 receives from the client terminals 111 to 113 instructions regarding execution of the application programs installed in the client terminals 111 to 113 respectively. The form management server 121 transmits processing results based on the instructions to browsers of the client terminals 111 to 113 which have transmitted the instructions.

More specifically, the form management server 121 includes functions for searching content data to be populated into a field in the form and outputting the form having the field into which the content data is populated. An application program for performing such functions is installed in the form management server 121.

A communication method between the form management server 121 and each of the client terminals 111 to 113 is not particularly determined. Further, the instruction may be directly transmitted to the form management server 121 (for example, the processing may be conducted using a keyboard or a mouse that the form management server 121 is equipped with), and the form management server 121 may conduct the processing based on the instruction.

According to the present exemplary embodiment, a case where data of content (content data) is populated into the field in the form is described as one example. The content data is abbreviated as the “data” as needed in the descriptions below.

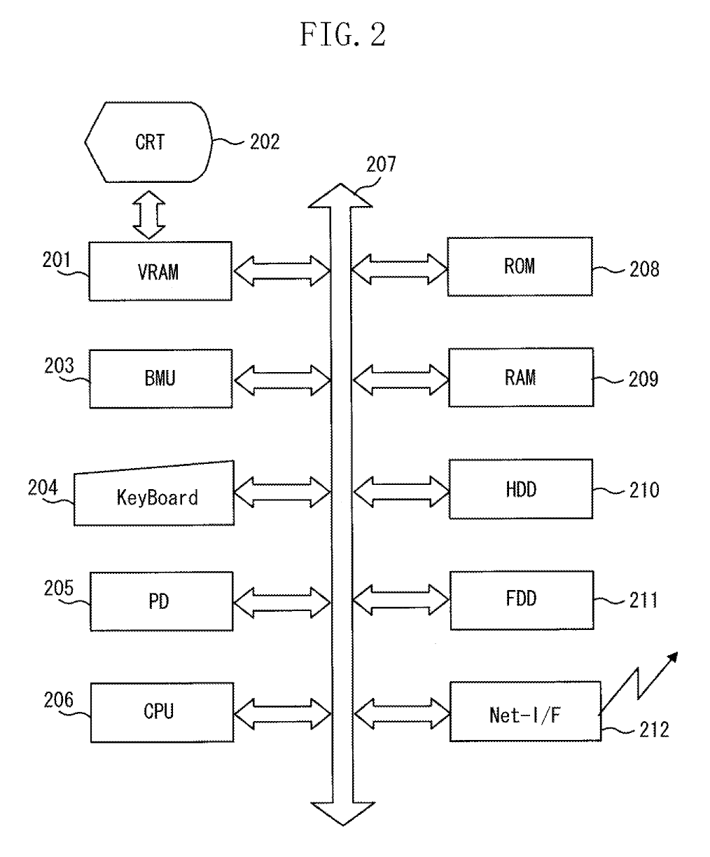

FIG. 2 illustrates one example of a configuration of the form management server 121 and the client terminals 111 to 113. In FIG. 2, a video random access memory (VRAM) 201 rasterizes and stores letters and images displayed on a display screen, e.g., a screen of a cathode-ray-tube (CRT) display device 202. A bit move unit (BMU) 203 controls transmission of the data between memories or between a memory and each device.

A keyboard 204 is a user interface equipped with various keys for inputting. A pointing device (PD) 205 is a user interface used for pointing to an icon on the screen of the CRT display device 202.

A central processing unit (CPU) 206 controls each part of the data search apparatus according to a control program recorded in a read only memory (ROM) 208, where the control program necessary for conducting processing described in the present exemplary embodiment is stored.

A random access memory (RAM) 209 is used as a work area when the CPU 206 performs each program stored in the ROM 208, or a temporary save area while an error is being handled. Additionally, as an external recording device, a hard disk drive (HDD) 210 and a floppy disk drive (FDD) 211 are included. The HDD 210 and FDD 211 are used for storing an application program, data, database, and library described below.

A network interface (Net-I/F) 212 controls and diagnoses the data on the LAN 101 in order to forward the data via the LAN 101 between external devices connected with each other via the LAN 101.

An input/output (I/O) bus 207 connects the units described above with each other and includes an address bus, data bus and control bus.

When the apparatus is turned on, the CPU 206 initializes the apparatus according to a boot program recorded in the ROM 208, downloads an operating system (OS) from the HDD 210, and subsequently operates various types of applications.

The program may be recorded in the HDD or the ROM. A storage medium for storing the program is not limited to a particular type.

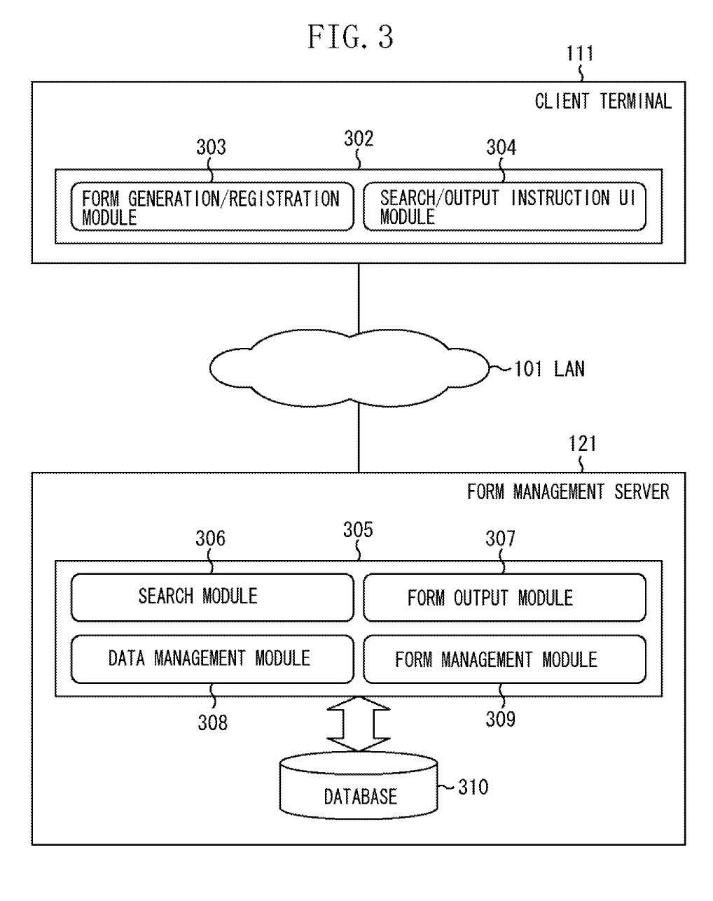

FIG. 3 illustrates one example of a configuration of modules in the form management server 121 and the client terminal 111. Since the client terminals 112 and 113 are the same as the client terminal 111, only the client terminal 111 will be described bellow. A protocol for communicating the data between the form management server 121 and the client terminal 111 is not limited to a particular protocol.

An application program 302 storing an operation of the client terminal 111 is installed in the client terminal 111. As a module in the application program 302, a form generation/registration module 303 and a search/output instruction user interface (UI) module 304 are recorded. The application program 302 may be of a general application type or an automatic delivery type that is supplied by a PLUG-IN, for example, via a website (WEB) browser.

The application program 305 in the form management server 121 is a server application program for managing the form and the data. The modules in the application program 305 include a search module 306, a form output module 307, a data management module 308 and a form management module 309. The CPU 206 loads each of the modules 306 to 309 into the memory (RAM 209) according to a request from the client terminal 111 to execute processing.

A database 310 stores data processed by each of the modules 306 to 309. The data can be registered in and taken from the database 310 as needed.

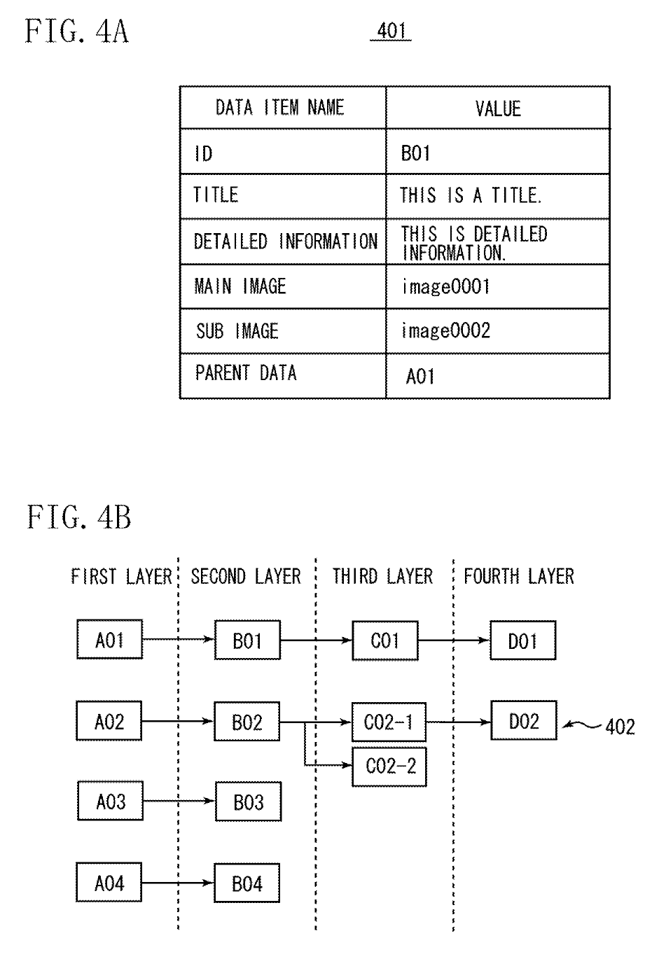

FIGS. 4A and 4B illustrate one example of hierarchical data. FIG. 4A illustrates one example of a configuration of individual data. FIG. 4B illustrates a plurality of hierarchical data groups obtained by layering each data.

In FIG. 4A, the data 401 includes an “ID”, “title”, “detailed information”, “main image”, “sub image”, and “parent data”. The “parent data” represents the data functioning as a parent of a hierarchical structure. One example illustrated in FIG. 4A shows a case where, when the data 401 has ID “B01”, the parent data of the data 401 having ID “B01” is the data ID “A01”.

As long as each item has the defined data structure, the data structure is not limited to the structure as illustrated in FIG. 4A. As long as a hierarchical data group 402 as illustrated in FIG. 4B is formed, any types of data structure may be employed. For example, the “parent data” that represents the data functioning as the parent of the layer structure may be recorded in a different table.

In FIG. 4B, as described above, the data identification data (ID) “A01” is the parent data of the data ID “B01” in a layer just below. Likewise, the data of ID “B01” is the parent data of the data ID “C01”, the data ID “C01” is the parent data of the data of ID “D01”.

A hierarchical data group in which the data of IDs “A01”, “B01”, “C01”, and “D01” respectively belong to the first to fourth layers is formed (A01→B01→C01÷D01 in FIG. 4B). Likewise, the data of ID “A02” is the parent data of the data of ID “B02”. The data ID of “B02” is the parent data of two data of the data of ID “C02-1” and the data of ID “C02-2”.

Further, the data of ID “C02-1” is the parent data of the data of ID “D02”. The data IDs of “A02”, “B02”, “C02-1”, “C02-2” and “D02” form a hierarchical data group.

Likewise, the data of IDs “A03” and “B03” form a hierarchical data group, and the data of IDs “A04” and “B04” also form a hierarchical data group.

The present exemplary embodiment will describe a form generation method with reference to the data 401 and the hierarchical data group 402 illustrated in FIGS. 4A and 4B. As described above, the present exemplary embodiment will describe a case where the hierarchical data (hierarchical data groups) is formed by specifying the “parent data”.

However, any method may be employed for generating and managing the hierarchical data (hierarchical data groups), as long as the hierarchical data can be formed. The method of generating the hierarchical data groups may include specifying the upper and lower relationships between the data belonging to each layer, and previously setting a structure of the layers and embedding the data therein.

According to the present exemplary embodiment, when searching the hierarchical data, the user specifies a higher limit and a lower limit in a range of a layer (layer range) to which the data to be finally searched belongs. In a hierarchical data group to which each data hit by (matching) the search condition belongs, the data within the layer range specified by the user is obtained and displayed as the final search result.

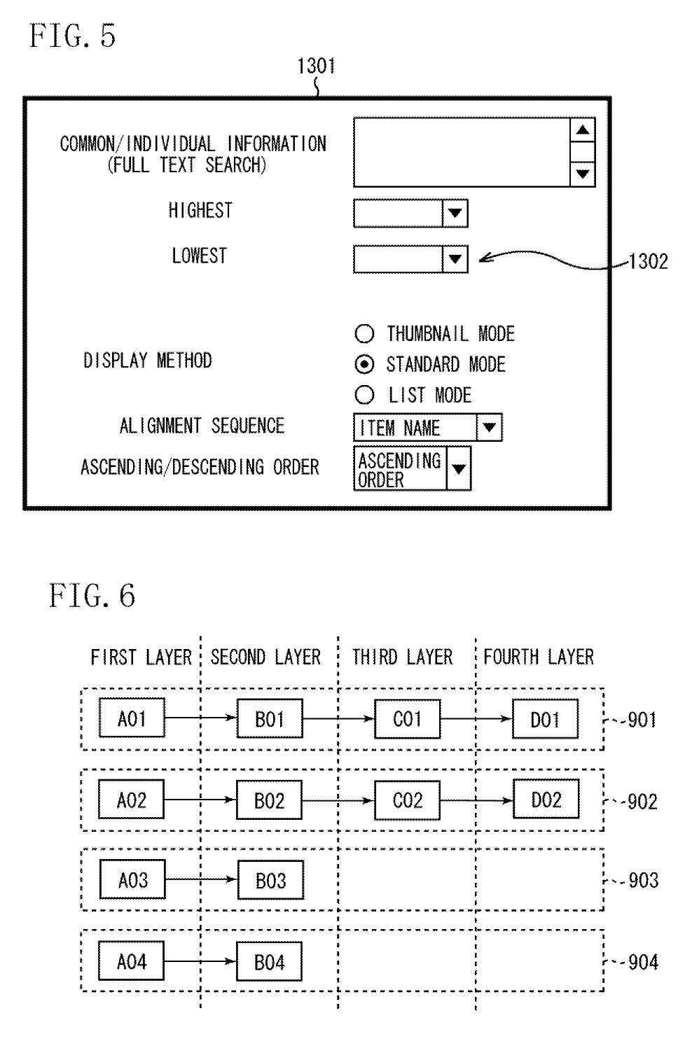

FIG. 5 illustrates one example of a search instruction screen displayed on the CRT display device 202 of the client terminal 111 when the data search is started.

A search instruction screen 1301 illustrated in FIG. 5 is displayed by an operation of the search/output instruction UI module 304. The search instruction screen 1301 displays a control 1302 for specifying the higher limit (uppermost) and lower limit (lowermost) of the layer range. The user operates the client terminal 111 to specify the highest layer and lowest layer to the control 1302 so that a multi-layered range described above can be specified.

FIG. 6 illustrates one example of the hierarchical data groups. Note that, for sake of convenience of description, the data of IDs “C02-1” and “C02-2” in the hierarchical data group 402 illustrated in FIG. 4B are integrated to the data of ID “C02”.

In FIG. 6, a hierarchical data group 901 is formed of four layers of A01→B01→C01→D01. Likewise, a hierarchical data group 902 is formed of four layers of A02→B02→C02→D02. A hierarchical data group 903 is formed of two layers of A03→B03, and a hierarchical data group 904 is formed of two layers of A04→B04.

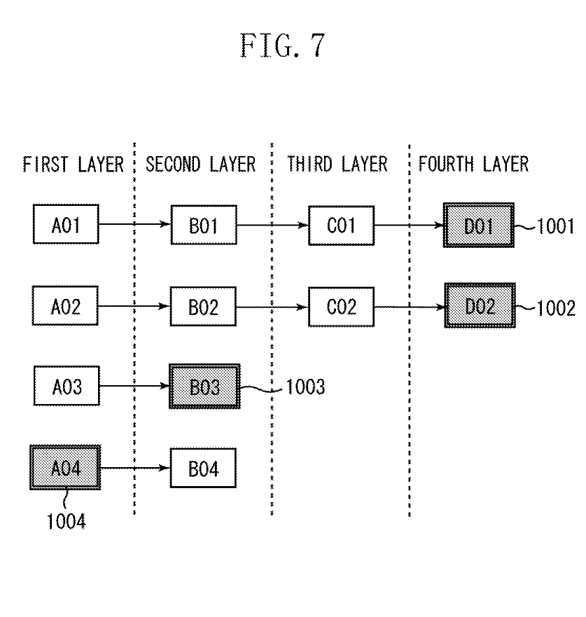

FIG. 7 illustrates one example of the data satisfying a search condition when the search is conducted on each of the data (data of IDs “A01” to “D02”) illustrated in FIG. 6 based on the search condition specified using the search instruction screen 1301 illustrated in FIG. 5.

In the example illustrated in FIG. 7, a double-lined rectangular representing the data satisfying the search condition is blacked out.

More specifically, the data 1001 with ID “D01”, the data 1002 with ID “D02”, the data 1003 with ID “B03”, and the data 1004 with ID “A04” are satisfying the search condition. The search described above can be realized by a general search method.

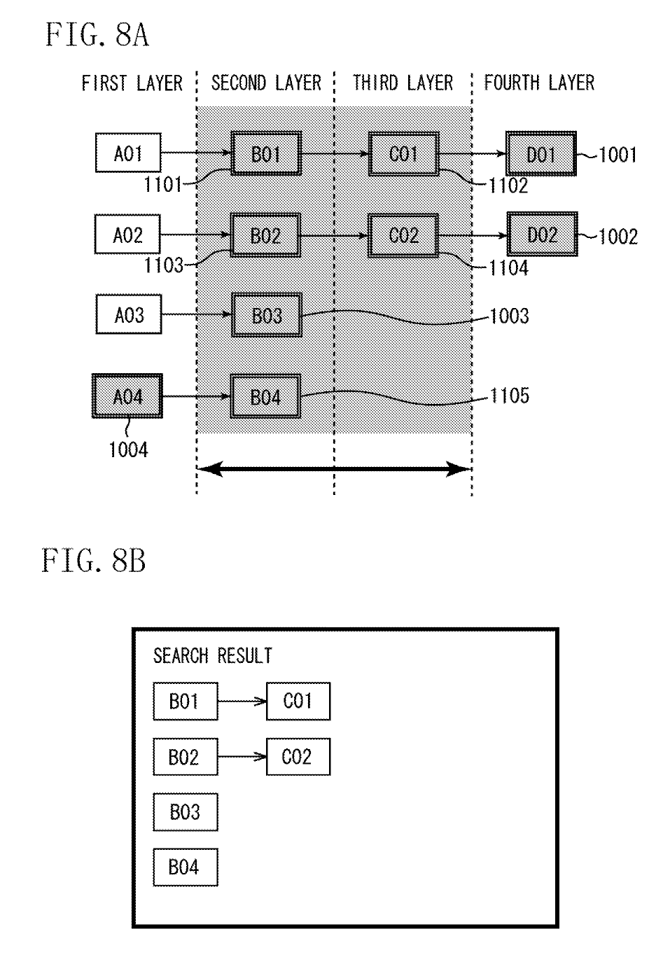

FIGS. 8A and 8B illustrate one example of a search method according to the present exemplary embodiment. Here, FIGS. 8A and 8B illustrate an example where the highest layer range of the data to be populated is specified as “2” and the lowest thereof is specified as “3” in the search instruction screen 1301 illustrated in FIG. 5.

As illustrated in FIG. 8A, the data 1101 with ID “B01”, the data 1102 with ID “C01”, and the data 1103 with ID “B02” are obtained as the satisfying data, the data 1104 with ID “C02”, the data 1003 with ID “B03”, and the data 1105 with ID “B04” are obtained as the satisfying data.

As illustrated in FIG. 7, the data 1001 with ID “D01” is satisfying (matching) the search condition. The layer range of the data that can be populated into the output form 701 is set to “2 to 3”.

Therefore, as the finally-satisfying data, the data can be obtained that belongs to the hierarchical data group 901 which the data 1001 belongs to, and further belongs to the second and third layers set as the layer range of the data that can be populated into the form 701 to be output.

More specifically, the data 1101 with ID “B01”, and the data 1102 with ID “C01” are obtained as the candidate data to be populated. Although the data 1001 is satisfying the search condition, the data 1001 itself is located outside the set layer range. Accordingly, the data 1001 is excluded from the final search result.

Similarly, as a result of the search, the data 1103 and 1104 are obtained that belong to the hierarchical data group 902 which the data 1002 satisfying the search condition belongs to, and further belongs to the second and third layers that are set as the layer range of the data that can be populated into the output form 701.

Since the data 1003 is satisfying the search condition and is located within the layer range of the data that can be populated into the output form 701, the data 1003 is obtained as the finally satisfying data.

In addition, as a result of the search, the data 1105 is obtained that belongs to the hierarchical data group 904 which the data 1004 satisfying the search condition belongs to, and further belongs to the second and third layers that are set as the layer range of the data that can be populated into the form 701.

FIG. 8B illustrates one example displaying the final search result. A screen 1106 illustrated in FIG. 8B is displayed on the CRT display device 202 of the client terminal 111.

As described above, the user specifies the highest and lowest of the layer range of the data that can be populated into each field. As a consequence, the data that is appropriate for the form content and populated, can be easily obtained as the final search result.

The processing for finally selecting the data to be populated from the search results can be realized by a general, conventional method. Accordingly, detailed description is not provided here. The search results illustrated in FIG. 8B is displayed only as one example. Search results can be displayed by any method as long as the data within the specified layer range can be displayed.

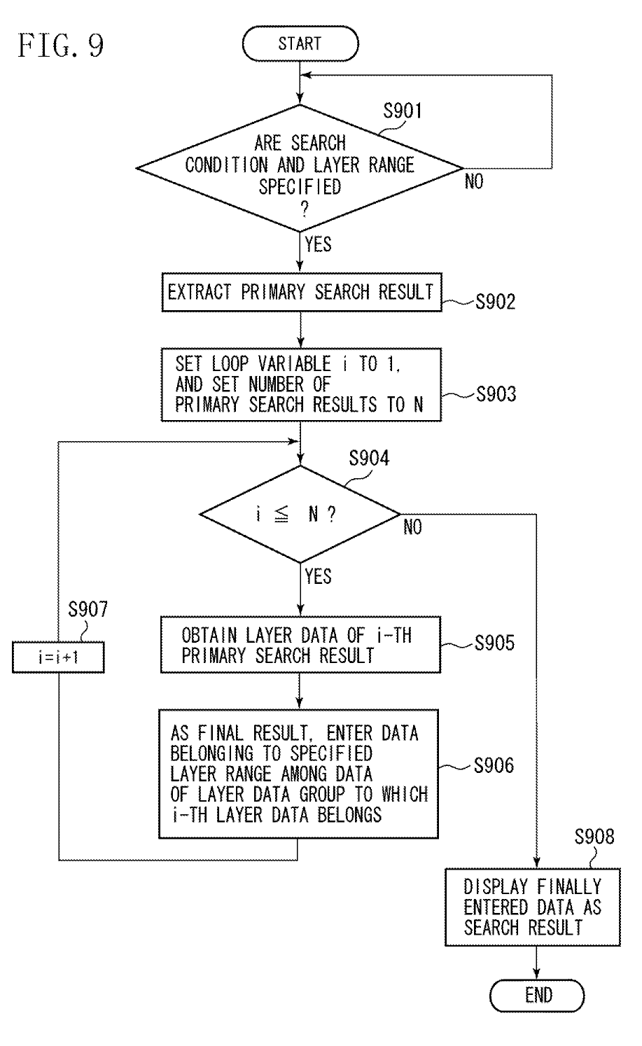

Next, with reference to a flowchart of FIG. 9, an example of an operation in the form generation system for searching a candidate of the data to be populated into the form is described. The search/output instruction UI module 304 illustrated in FIG. 3 instructs the form management server 121 to conduct the search processing for the data to be populated as described above based on an operation of the user. Then, the search module 306 conducts the search processing described above, and the search results are displayed.

First, in step S901, the search/output instruction UI module 304 waits until a search condition and a layer range are specified by the operation of the user in the search instruction screen 1301. Here, the processing waiting until the search condition and the layer range are specified is conducted as one process, however, the processing may be conducted separately.

The layer range is specified by the processing in step S901, so that the layer range to which the data to be populated into the form is specified. The specified layer range is applied to the final search result. According to the present exemplary embodiment, as described above, one example of an acquiring unit and an input unit can be realized by conducting the process of step S901.

When the search condition and the layer range are specified (YES in step S901), the processing proceeds to step S902. Instep S902, the search module 306 accesses the database 310 based on the search condition specified in step S901 to conduct the search for the data (extracting the primary search results) that satisfies the search condition.

The search processing conducted in step S902 may be conducted by a general method, which is not limited to a particular type. According to the present exemplary embodiment, as described above, the second search unit can be realized by conducting the processing of step S902.

Next, in step S903, the search module 306 sets the number of the primary search results (the number of the extracted data ) extracted in step S902 to “N”, and further sets a loop variable “i” to 1 to set a value for the loop.

Next, in step S904, the search module 306 determines whether the number of the primary search results “N” is equal to or greater than the loop variable “i”. When it is determined that the number of the primary search results “N” is less than the loop variable “i” (NO in step S904), the processing proceeds to step S908.

On the other hand, when the number of the primary search results “N” is equal to or greater than the loop variable “i”, (YES in step S904), the processing proceeds to step S905.

In step S905, the search module 306 obtains (makes a listing) the data of a hierarchical data group which the “i”th primary search result (“i”th data satisfying the search condition) belongs to. For example, when the data 1001 with ID “D01” illustrated in FIG. 7 is included in the primary search results, the search module 306 obtains all the data belonging to the hierarchical data group 901 illustrated in FIG. 6.

Next, in step S906, as the final search result, the search module 306 enters the data included within the “hierarchical range” obtained in step S901 from among the data in the hierarchical data group obtained in step S905. In the process of step S906, the adjustment processing is conducted to avoid the already entered data from double-entry.

Subsequently, the processing proceeds to step S907. The search module 306 adds “1” to the loop variable “i” so that the following processing can be conducted on the primary search result.

Steps S904 to S907 described above are a series of loop processing. The loop processing is repeated the number of times of the primary search results (N times) so that the search results based on the specified “form and search condition” can be obtained. Thus, according to the present exemplary embodiment, the search unit can be realized by conducting the processing of steps S904 to S907.

When the processing proceeds to step S908, the search module 306 transmits the data about the results of the search conducted as described above to the client terminal 111. Then, the search/output instruction UI module 304 displays the data (search results) that is finally entered in step S906, based on the data about the search results such that the user can realize the parent-child relationship (hierarchical configuration) as illustrated in FIG. 8B. However, the method of displaying the search results is not limited to the present exemplary embodiment. According to the present exemplary embodiment, as described above, an output unit can be realized by conducting the processing of steps S904 to S907.

Thus, according to the present exemplary embodiment, using the search instruction screen 1301, the search condition and the layer range are specified to designate the layer of the data that can be populated into the form. Therefore, from among the hierarchical data, the user can obtain only the data belonging to the layer desired by the user as the search results, resulting in realizing a more-effective data search.

Next, a second exemplary embodiment of the present invention will be described. According to the first exemplary embodiment described above, the layer range is specified every time an instruction for conducting a search is given. In contrast, according to the present exemplary embodiment, the layer range is not specified every time an instruction for conducting a search is given, but the layer range is previously set as search information.

Thus, the present exemplary embodiment and the above-described first exemplary embodiment are different mainly in the method of setting the layer range. Therefore, in description of the present exemplary embodiment, the similar parts to the first exemplary embodiment described above are denoted by same reference numerals as FIGS. 1 to 9, and the detailed description thereof will not be repeated.

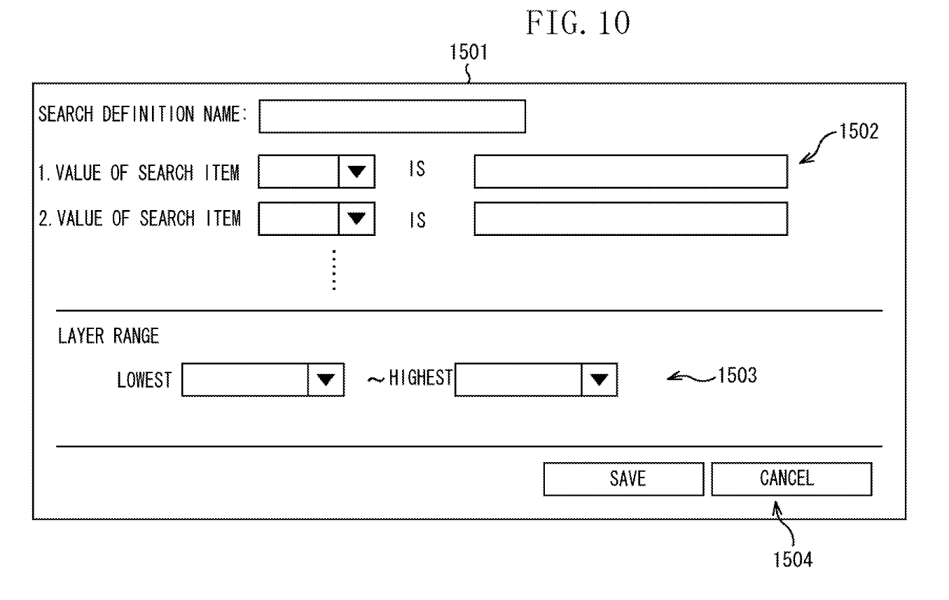

FIG. 10 illustrates one example of a setting screen displayed on the CRT display device 202 of the client terminal 111 when search information including the layer range is previously set.

The setting screen 1501 illustrated in FIG. 10 is displayed by an operation of the search/output instruction UI module 304. In FIG. 10, a control group 1502 includes a control for inputting a search definition name that specifies a name for holding the search information and a control for inputting a setting of the search condition.

For example, a search condition such as “value of search item ‘item name’ is ‘apple’” can be specified. Here, as an example, a set of search information is expressed as a search definition and its designation is a search definition name. However, the control group can be specified by various methods such as specifying an item and a search expression, or specifying the range. Therefore, the methods are not limited to the example illustrated in FIG. 10.

The control group 1503 includes a control for inputting the lower limit and higher limit of the layer range. The layer range can be specified by designating the control group 1503.

A button group 1504 controls an end of inputting on the setting screen 1501. To make the setting input in the setting screen 1501 valid, the user presses a “SAVE” button. Subsequently, the search/output instruction UI module 304 outputs the content of the search definition to the form management server 121. The form management module 309 saves the contents of the search definition in the database 310. According to the present exemplary embodiment, the storage unit can be realized as described above. On the other hand, when the user presses a “CANCEL” button, the search/output instruction UI module 304 does not make the setting input on the setting screen 1501 valid, but rather retains the current (previously set) settings.

According to the present exemplary embodiment, a plurality of such search definitions can be recorded. In such a case, when starting the search of the data, the user can select the search definition (for example, a search definition name) from among the plurality of search definitions so that the “search condition and layer range” included in the search definitions can be read out from the database 310.

Thus, according to the present exemplary embodiment, since the search condition and the layer range are previously specified, the more effective search of the data can be conducted.

According to the present exemplary embodiment, in a case where the data to be populated into the form is searched, the waiting processing is conducted in step S901 in FIG. 9 until the search definition previously set as described above is specified. Since other processing can be easily assumed by analogy from the flowchart illustrated in FIG. 9, the detailed description will not be provided.

Next, a third exemplary embodiment of the present invention will be described. According to the first exemplary embodiment, the layer range is specified at the time of the search. According to the second exemplary embodiment, the layer range is previously set. On the other hand, according to the present exemplary embodiment, when the search is conducted, the layer range is automatically obtained from among the information about the form specified by the user.

Thus, the present exemplary embodiment and the above-described first and second exemplary embodiments are different mainly in the processing for obtaining the layer range. Therefore, in description of the present exemplary embodiment, the similar parts to the first and second exemplary embodiments described above are denoted by the same reference numerals as FIGS. 1 to 10, and the detailed description thereof will not be repeated.

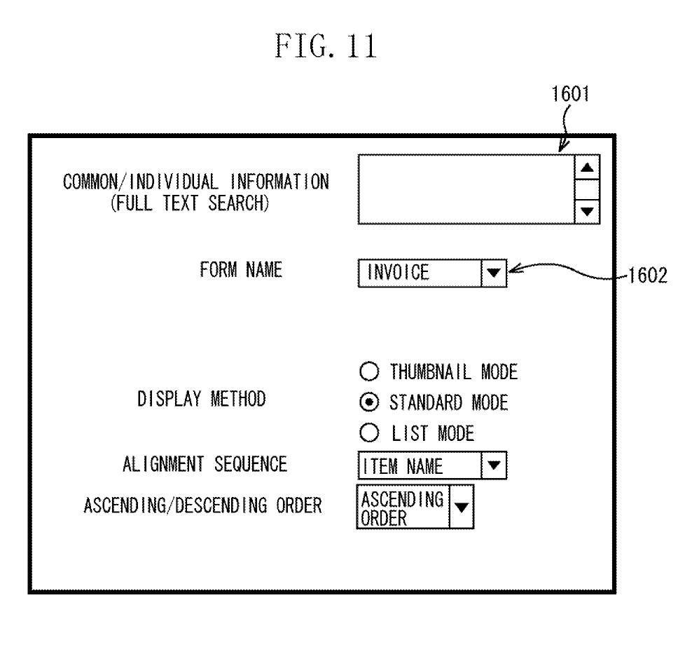

FIG. 11 illustrates one example of a search instruction screen displayed on the CRT display device 202 of the client terminal 111 when the data search is started.

On a search instruction screen 1601, the search condition and the form to be output are specified. On the search instruction screen 1601, instead of the “control 1302 specifying the layer range” illustrated in FIG. 5, a control 1602 specifying the form to be used for outputting is displayed.

When an instruction for the search is given after the operation has been conducted on the search instruction screen 1601, the higher limit and lower limit of the layer of all the fields are obtained from information of each field of the form specified by the control 1602 to designate the layer range.

The specifics of processing for searching the data satisfying the search condition and processing for extracting the data belonging to the layer range from the search results can be conducted similarly to the first exemplary embodiment illustrated in FIGS. 6 to 8A and 8B. The present exemplary embodiment and the first exemplary embodiment are different only in the sources for obtaining information of the layer ranges. Therefore, the detailed description will not be provided here.

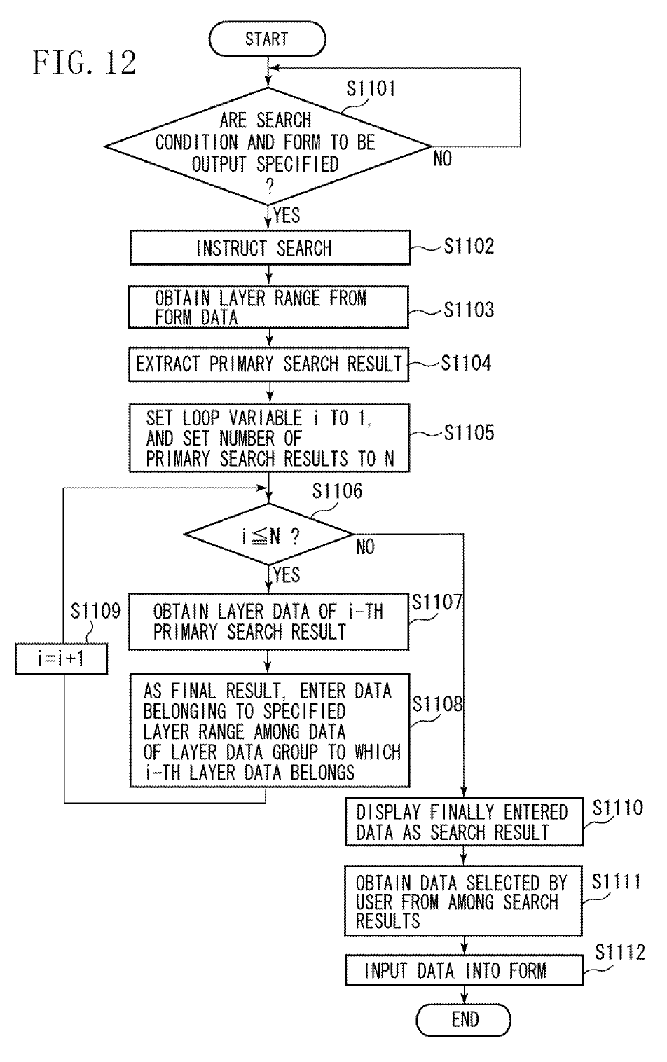

Next, with reference to the flowchart of FIG. 12, an operation in the form generation system for outputting the form which the data is populated into is described as an example. The search/output instruction UI module 304 illustrated in FIG. 3 instructs the form management server 121 to conduct the search for the data to be populated into the form based on an operation by the user. Subsequently the search module 306 conducts the search processing, and the form output module 307 conducts the form output processing using the search results.

First, in step S1101, the search/output instruction UI module 304 waits until the search condition and the form to be output are specified by the operation of the user. Here, the processing waiting until the search condition and the form to be output are specified is conducted as one process, however, the processing may also be conducted separately.

In a present case, it is assumed that the layer of the data that can be populated into the field is set to all the fields of all the forms that have possibilities to be specified. Accordingly, the form is specified by the processing in step S1101 so that the layer of the data that can be populated into the form is specified. Thus, according to the present exemplary embodiment, one example of an input unit and a reception unit can be realized by conducting the process of step S1101.

When the search condition and the form to be output are specified (YES in step S1101), the processing proceeds to step S1102. In step S1102, the search/output instruction UI module 304 generates the data indicating the specified “search condition and form” and transmits the data to the form management server 121.

Next, in step S1103, the search module 306 accesses the database 310 and obtains the data of the specified form. Then, the search module 306 obtains the value of the layer of the data that can be populated into the field based on the obtained data, and the layer range of the data that can be populated into each field is obtained from the largest and smallest values. As described above, the layer range obtained by the process in step S1103 is adapted for the final search result. Thus, according to the present exemplary embodiment, one example of the acquiring unit can be realized by conducting the processing of step S1103.

Next, in step S1104, the search module 306 accesses the database 310 based on the search condition specified in step S1101 and conducts the search (extracting the primary search results) for the data satisfying the search condition. The search processing of step S1104 may be conducted by a general method which is not limited to a particular type. According to the present exemplary embodiment described above, the second search unit can be realized by conducting the processing of step S1104.

Next, in step S1105, the search module 306 sets the number of the primary search results (the number of the extracted data) extracted in step S1103 to “N”, and further sets a loop variable “i” to 1 to set a value for the loop.

Next, in step S1106, the search module 306 determines whether the number of the primary results “N” is equal to or greater than the loop variable “i”. When it is determined that the number of the primary search results “N” is less than the loop variable “i” (NO in step S1106), the processing proceeds to step S1110.

In contrast, when the number of the primary search results “N” is equal to or greater than the loop variable “i” (YES in step S1106), the processing proceeds to step S1107.

In step S1107, the search module 306 obtains the data of a hierarchical data group which the “i”th primary search result (“i”th data satisfying the search condition) belongs to. For example, when the data 1001 with ID “D01” illustrated in FIG. 7 is included in the primary search results, the search module 306 obtains all the data belonging to the hierarchical data group 901 illustrated in FIG. 6.

Next, in step S1108, as the final search result, the search module 306 enters the data included within the “layer range” obtained in step S1103 from among the data in the hierarchical data group obtained in step S1106. In the process of step S1108, the adjustment processing is conducted to avoid the entered data from double-entry.

Subsequently, the processing proceeds to step S1109, and the search module 306 adds “1” to the loop variable “i” to conduct the following processing on the primary search result.

Steps S1106 to S1108 as described above are a series of loop processing. The loop processing is repeated the number of times of the primary search results (N times) to obtain the search results based on the specified “form and search condition”. Thus, according to the present exemplary embodiment, the search unit can be realized by conducting the processing of steps S1106 to S1109.

When the processing proceeds to step S1110, the search module 306 transmits to the client terminal 111 the data about the results of the search conducted as described above. Then, the search/output instruction UI module 304 displays the data (search results) that is finally entered in step S1108 based on the data about the search results such that the user can realize the parent-child relationship (hierarchical configuration) as illustrated in FIG. 8B. The method of displaying the search results is not limited to the diagram illustrated in the FIG. 8B.

Next, in step S1111, when the data desired by the user is finally selected from among the search results displayed by step S1110, the search/output instruction UI module 304 obtains the data. This processing can be realized by a general method, which is not limited to a particular type.

Finally, in step S1112, the form generation/registration module 303 populates the data selected by the user in step S1111 into each field of the form specified in step S1101. This processing can be also realized by a general method, which is not limited to a particular kind.

Next, one example of a method will be described where the layer which the data that can be populated into the field of the form belongs to is set for the field in the form.

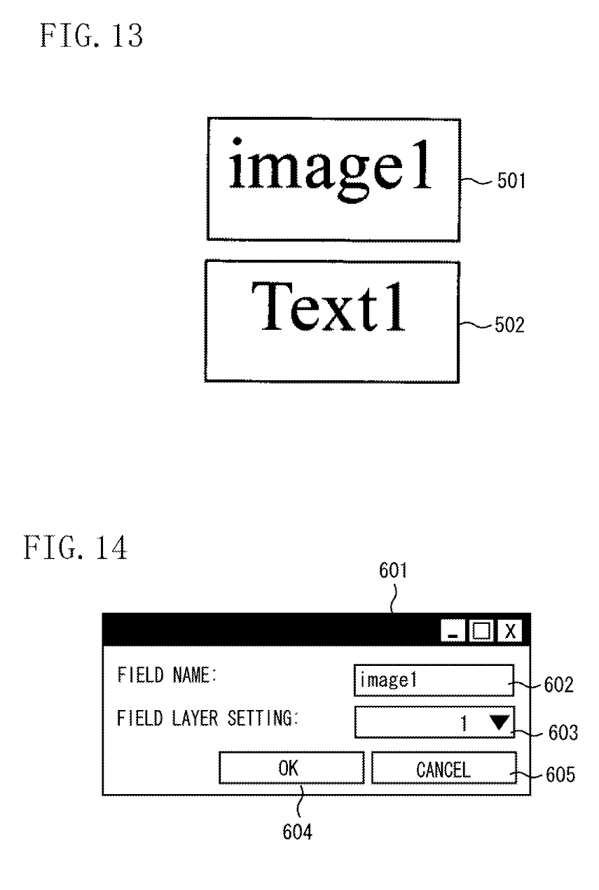

FIG. 13 illustrates one example of each field defined in the form. An image (image data) is populated into a field 501. Text (text data) is populated into a field 502. The fields 501 and 502 are used (set) in combination in the form to generate the form.

FIG. 14 illustrates one example of a method of setting layer information of the field 501 illustrated in FIG. 13. As illustrated in FIG. 14, according to the present exemplary embodiment, the user of the client terminal 111 sets the layer information of the field using a setting dialog 601 displayed on the CRT display device 202 of the client terminal 111.

In the setting dialog 601, a field name 602 represents a name of the field currently selected. Here, a name of the field 501 “image1” illustrated in FIG. 13 is selected. A layer setting 603 of the field describes a layer of the field selected by the field name 602. In the present case, “1” is set as a layer setting of the field. A value of the layer setting 603 is changed to change the layer of the data that can be populated into the field selected by the field name 602.

An “OK” button 604 and a “CANCEL” button 605 respectively instruct to update (set)/to not update the setting of the “layer information of the field 501” in the setting dialog 601. The layer of the data targeted by each field is specified using the setting dialog 601 as illustrated in FIG. 14 so that all layers (using the setting dialog 601) of the data to be used in the form can be specified.

FIG. 14 illustrates an example of setting only the layer of the field, however, when the layer is set, the data items of each field can be also set. As long as the layer of the data to be populated into the field can be specified, a method of setting the layer information of the field is not limited to a particular one.

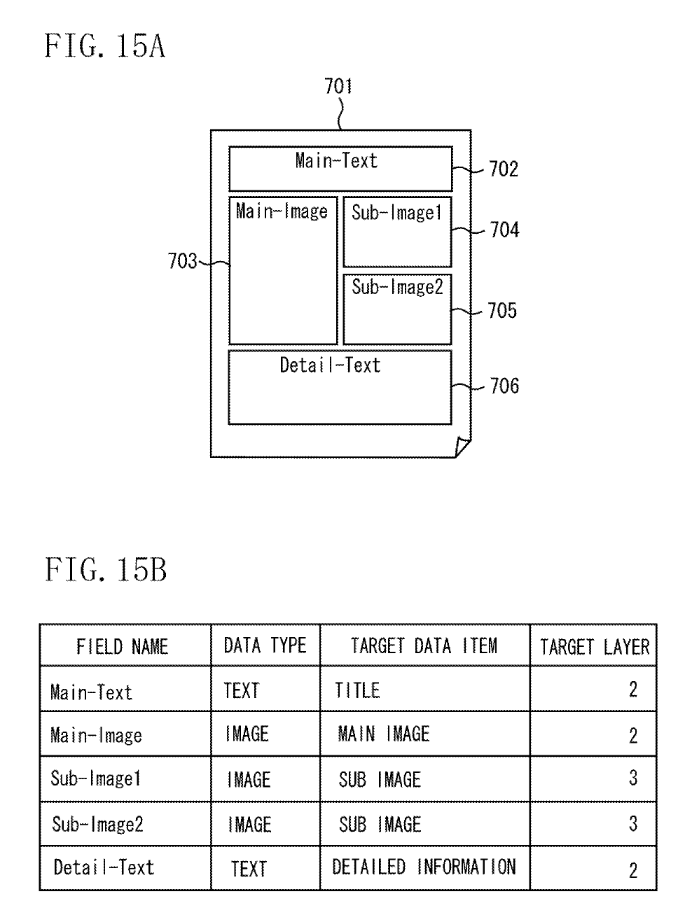

FIGS. 15A and 15B illustrate one example of the form where the layer of the data to be populated into each field is set.

In FIG. 15A, fields 702 to 706 are defined in a form 701. In FIG. 15B, the contents of the fields 702 to 706 illustrated in FIG. 15A are illustrated in a chart style. The field 702 has a name “Main-Text” and is used for text data. The layer of the data that can be populated into the field 702 is set to “2”, and a data item name of the data to be populated thereinto is set as “title”.

The field 703 has a name “Main-Image” and is used for image data. The layer of the data that can be populated into the field 703 is set to “2”, and a data item name of the data to be populated thereinto is set as “main image”.

The field 704 has a name “Sub-Image1” and is used for image data. The layer of the data that can be populated into the field 704 is set to “3”, and a data item name of the data to be populated thereinto is set as “sub image”. Likewise, the field 705 has a name “Sub-Image2” and is used for image data. The layer of the data that can be populated into the field 705 is set to “3”, and a data item name of the data to be populated thereinto is set as “sub image”. The field 706 has a name “Detail-Text” and is used for text data. The layer of the data that can be populated into the field 706 is set to “2”, and a data item name of the data to be populated thereinto is set as “detail-information”.

The form management server 121 and the client terminal 111 obtain values of the layer (target layer in FIG. 15B) of the data to be populated to obtain the layer range (highest and lowest) set for each of the fields 702 to 706 in the form 701. In the example illustrated in FIGS. 15A and 15B, since the lowest value of the layer of the data that can be populated is set to “2”, and the highest value thereof is set to “3”, the layer range of the data that can be populated is set to “2” or greater to “3” or less than “3”.

According to the present exemplary embodiment, when the field is generated, the data layer information is set by the form generation/registration module 303. More specifically, for example, the form generation/registration module 303 sets the data layer information to the field in a sample for generating a form selected by the user. More specifically, the form generation/registration module 303 sets a value of the “layer information of the field” selected in the layer setting 603 to the field selected by a field name 602 in the setting dialog 601 to set the layer information of the data.

Subsequently, the form generation/registration module 303 transmits to the form management server 121 the data of the form including the set “layer information of the data”. The form management module 309 registers the transmitted data of the form in the database 310. As described above, since the processing for setting the data layer information is easily assumed by analogy, a flowchart illustrating the process is not included. According to the present exemplary embodiment, the form management module 309 registers the transmitted data of the form in the database 310 to embody one example of the storage unit.

According to the present exemplary embodiment as described above, the search is conducted using the form where the layer to which the data that can be populated into the field of the form belongs is set to each field. In other words, the layer range of the data that can be populated into the form is obtained from the form specified by the user.

Since inappropriate data for the form selected by the user can be removed from the search results by the processing described above, the user can easily select the desired data. As a result, effective form generation (output) can be realized. Further, also in the first and second exemplary embodiments, in a manner similar to steps S1111 and S1112 in the FIG. 12 of the present exemplary embodiment, the processing for populating and outputting the searched data may be conducted.

Next, a fourth exemplary embodiment of the present invention will be described. The third exemplary embodiment described above describes an example where the layer information of the data is set to each field in the form using the setting dialog 601. On the other hand, the present exemplary embodiment will describe an example where the layer information of the data is set to each field in the form by a drag and drop operation of the user in the client terminal 111.

The present exemplary embodiment and the third exemplary embodiment are different only in a part of the method for setting the layer information of the data to each field in the form. Therefore, in description of the present exemplary embodiment, the similar parts to the first to third exemplary embodiments described above are denoted by the same reference numerals as FIGS. 1 to 15A and 15B, and the detailed description thereof will not be repeated.

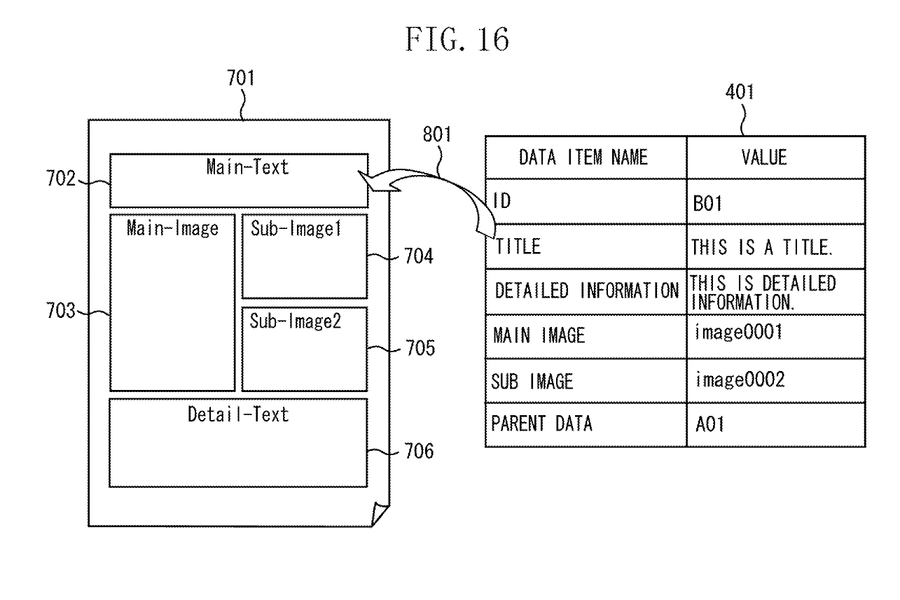

FIG. 16 illustrates one example of processing for defining the data item name for each field in the form when the form is generated. FIG. 16 illustrates an example where the data item name of the data 401 illustrated in FIG. 4A is defined for each of the fields 702 to 706 in the form 701 illustrated in FIG. 15A. A screen as illustrated in FIG. 16 is displayed on the screen of the CRT display device 202 of the client terminal 111.

In FIG. 16, an arrow 801 shows that the data item name “title” in the data 401 is dragged and dropped at the field 702 (a field name is “Main-Text”) in the form 701. By a simple operation of drag and drop, the data item name to the field 702 can be set and at the same time, the layer information of the data is set.

In this case, as illustrated in FIG. 4B, since the data ID “B01” belongs to the second layer, the data layer is automatically set to “2” for the field 702 by the operation of drag and drop.

According to the present exemplary embodiment, the form generation/registration module 303 receives the drag and drop operated by the user and obtains the value of the “data layer” corresponding to the dragged data item name. Subsequently, the form generation/registration module 303 sets the obtained value to the field where the data item name has been dropped so as to set the layer information of the data. As described above, since the processing for setting the layer information of the data can be easily assumed by analogy, a flowchart illustrating the process is not included.

Each unit forming the data search apparatus according to the present invention described above and each step of the data search method thereof can be realized by the operation of the programs stored in the RAM or ROM in the computer. The programs and the computer-readable storage media storing the programs are included in the present invention.

Further, the present invention, for example, may be applied to the exemplary embodiments such as a system, apparatus, method, and program, more specifically, and to a system formed of a plurality of devices. Further, the present invention may be applied to an apparatus formed of one device.

A program (program corresponding to the flowchart illustrated in FIG. 9 or 12) (software) that realizes each of the functions of the above-described exemplary embodiments may be directly or remotely supplied to the system or the apparatus. The present invention further includes a case where the system or the computer of the apparatus reads out and executes the program code to realize the functions of the exemplary embodiments.

Therefore, the present invention is further realized by program code that is installed in the computer to realize the function processing of the exemplary embodiments according to the present invention.

In that case, as long as the computer program has a function as a program, the computer program may have any form such as a program performed by an object code or an interpreter, and script data supplied to the OS.

As the storage medium for supplying the program, a floppy disk, a hard disk, an optical disk, a magneto-optical disc (MO), a compact disc-read-only memory (CD-ROM), a CD-recordable (CD-R), a CD-rewritable (CD-RW), a magnetic tape, a nonvolatile memory card, a ROM, and a digital versatile disk (DVD) (DVD-ROM, DVD-R), for example, can be used.

Additionally, methods of supplying the program include a method of connecting to a website of the Internet using a browser of a client's computer and downloading in the storage medium such as the hard disk the computer program itself of the present invention from the website, or a file that is compressed and includes an automatically-installing function.

Further, the present invention can be realized by dividing the program code forming the program of the present invention into a plurality of files and downloading each of the files from the different websites. More specifically, a World Wide Web (WWW) server can be used for enabling a plurality of users to download the program files for realizing the function processing of the present invention by the computer.

Further, the storage media such as a CD-ROM that records an encoded program of the present invention may be distributed to the users. The user who satisfies a certain condition is allowed to download key information for decoding the program from the website via the Internet. Thus, the present invention can be further realized by the encoded program which is performed using the key information obtained by downloading and installing in the computer.

The above-described functions of the exemplary embodiments can be realized by performing the program read out by the computer. Additionally, based on the instructions of the program, the OS running in the computer can perform a part of or all of the actual processing, by which the functions of the above-described exemplary embodiments can be realized.

Further, the program read out from the storage medium can be written in a memory equipped in a function extension board inserted into the computer or a function extension unit connected to the computer. Subsequently, based on the instruction of the computer, the CPU equipped in the function extension board or the function extension unit performs a part of or all of the actual processing, by which the functions of the above-described embodiments are realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-341283 filed Dec. 28, 2007, which is hereby incorporated by reference herein in its entirety.

What is claimed is:

1. A data search apparatus configured to search for content data that is to be populated into a field defined in a form, from among hierarchical data, the data search apparatus comprising:
an acquiring unit configured to acquire information about a layer range of content data that can be populated into the field;
a search unit configured to search for content data within the layer range acquired by the acquiring unit, as a candidate of the content data to be populated into the field; and
an output unit configured to output the candidate of the content data satisfying the search conducted by the search unit.

2. The data search apparatus according to claim 1, further comprising a reception unit configured to receive a specification of a form to be output,
wherein the acquiring unit acquires information set to the form received by the reception unit as information about the layer of the content data that can be populated into the field defined in the form.

3. The data search apparatus according to claim 2, further comprising a storing unit configured to store, in a storage medium, information about a layer set to the field defined in the form,
wherein the acquiring unit acquires the information set to the form received by the reception unit from among the information stored by the storing unit.

4. The data search apparatus according to claim 1, wherein the acquiring unit acquires a higher limit and a lower limit of the layer of the content data that can be populated into the field every time the search is conducted.

5. The data search apparatus according to claim 1, further comprising a storage unit configured to store in a storage medium the information about the layer range of the content data that can be populated into the field,
wherein the acquiring unit acquires the information about the layer range of the content data that can be populated into the field from among the information stored by the storage unit.

6. The data search apparatus according to claim 1, further comprising:
an input unit configured to input a search condition of the content data to be populated into the field; and
a second search unit configured to search for content data satisfying the search condition input by the input unit from among the hierarchical content data,
wherein the search unit searches the content data within the layer range acquired by the acquiring unit from among the hierarchical content data including the content data searched by the second search unit, as a candidate of the content data to be populated into the field.

7. A method of searching for content data to be populated into a field defined in a form from among hierarchical data, the method comprising:
acquiring information about a layer range of the content data that can be populated into the field;
searching for the content data within the acquired layer range as a candidate of the content data to be populated into the field; and
outputting the candidate of the content data obtained by the searching.

8. The method according to claim 7, further comprising:
receiving a specification of a form to be output; and
acquiring information set to the received form as the information about the layer of the content data that can be populated into the field defined in the form.

9. The method according to claim 8, further comprising:
storing, in a storage medium, information about a layer range set to the field defined in the form; and
acquiring information set to the received form from among the stored information.

10. The method according to claim 7, further comprising obtaining a higher limit and a lower limit of the layer of the content data that can be populated into the field every time the search is conducted.

11. The method according to claim 7, further comprising:
storing in a storage medium the information about the layer range of the content data that can be populated into the field; and
acquiring the information about the layer range of the content data that can be populated into the field from among the stored information.

12. The method according to claim 7, further comprising:
inputting a search condition of the content data to be populated into the field;
searching for the content data satisfying the input search condition from among the hierarchical content data; and
searching for the content data within the acquired layer range from among the hierarchical content data including the searched content data as a candidate of the content data to be populated into the field.

13. A computer-readable storage medium that stores a control program enabling a computer to conduct a method of searching for content data to be populated into a field defined in a form from among hierarchical data comprising:
acquiring information about a layer range of content data that can be populated into the field;
searching for content data within the acquired layer range as a candidate of the content data to be populated into the field; and
outputting the information about the searched content data.
